(19) United States
(12) Patent Application Publication
(10) Pub. No.: US 2021/0043939 A1
(43) Pub. Date: Feb. 11, 2021

(54) COATING FOR LI ANODE PROTECTION AND BATTERY COMPRISING THE SAME

(71) Applicant: REPSOL, S.A., Madrid (ES)

(72) Inventors: Rodrigo PARIS ESCRIBANO, Móstoles (ES); Juan NICOLÁS AGUADO, Móstoles (ES); Eneko AZACETA MUÑOZ, Donostia-San Sebastián (ES); José Alberto BLAZQUEZ MARTÍN, Donostia-San Sebastián (ES); Olatz LEONET BOUBETA, Donostia-San Sebastián (ES); Idoia URDAMPILLETA GONZALEZ, Donostia-San Sebastián (ES); Oscar MIGUEL CRESPO, Donostia-San Sebastián (ES)

(73) Assignee: REPSOL, S.A., Madrid (ES)

(21) Appl. No.: 16/966,879

(22) PCT Filed: Feb. 4, 2019
(86) PCT No.: PCT/EP2019/052664

§ 371 Date: Jul. 31, 2020

(30) Foreign Application Priority Data
Feb. 5, 2018 (EP) 18382060.4

(51) Int. Cl. H01M 4/62; H01M 10/052; H01M 4/38; H01M 4/36

(52) U.S. Cl. CPC H01M 4/628; H01M 10/052; H01M 2004/027; H01M 4/366; H01M 4/382

(57) ABSTRACT

It is provided a lithium metal anode coated with a protective monolayer disposed on at least a portion of the lithium metal anode, the protective monolayer consisting of a polymer; at least one inorganic particle selected from the group consisting of Al₂O₃, MnO, MnO₂, SiO₂, TiO₂, ZnO, ZrO₂, Fe₂O₃, CuO, a silicate, an aluminosilicate, a borosilicate, and an oxysalt, or any one of the mentioned inorganic particles which are functionalized; wherein the protective monolayer has a thickness from 0.01 to 10 μm, the inorganic particles have an average diameter from 1 to 500 nm, and the at least one inorganic particle is in an amount of 0.01 to 30 wt % related to the amount of polymer. It is also provided a method for the preparation of the protected anode, as well as a lithium metal battery comprising it.

This application claims the benefit of European Patent Application EP18382060.4 filed on Feb. 5, 2018.

### TECHNICAL FIELD

The present invention relates to the field of rechargeable batteries. In particular, it is related to a coating for Li anode protection, as well as to the coated Li anode and to a battery comprising the same.

### BACKGROUND ART

Lithium Metal Batteries (LMB) such as Li—S, Li-air, and solid-state own the potential to surpass the limitations of Li-Ion Batteries (LIB) opening up new fields of applications with high energy storage demand (e.g. electric vehicle with long distance mobility, green energy storage). However, the intrinsic properties of metallic Li generates several issues regarding safety and device instability leading to limited cycle-life. Consequently, the successful stabilization/protection of Li anode is mandatory for a realistic development of LMB technology.

The highly reactive nature of Li triggers different processes with, generally, detrimental effect on the cycle-life of the battery such as liquid electrolyte degradation, Solid-Electrolyte-Interface (SEI) formation, corrosion of the Li anode due to the presence of minor traces of water in the electrolyte, Li dendrite formation, Li passivation through polysulfide shuttle effect in Li—S batteries.

Particularly, in Li—S batteries, the so called shuttle effect is responsible of detrimental electrochemical side-reactions between polysulfides and Li which ends with the precipitation of insulating Li₂S and Li₂S₂ on the anode. Consequently, a premature death of the device takes place by the passivation of Li metal interface.

The different strategies that have been proposed to address all the shortcomings related to the Li anode can be classified into two main groups: 1) controlled Li⁺ conductive SEI formation and 2) Li coating with different materials to avoid electrolyte degradation and dendrite growth.

One of the most extended approaches to generate a stable SEI on Li anode is to induce it by adding LiNO₃ in the electrolyte (cf. Zhang, S. S., “Role of LiNO₃ in rechargeable lithium/sulfur battery” Electrochim. Acta, 2012, Vol. 70, p. 344-348). However, the SEI is not robust enough to prevent from moisture or dendrite formation.

On the other side, the controlled protection of Li anode with organic and/or inorganic materials has been disclosed to have a beneficial effect on the performance of the battery. Approaches based on polymeric coatings in combination with electric conductive polymers and ion conductive polymer films have been disclosed aiming at avoiding dendrite formation and protecting from moisture of the electrolyte (cf. Hu Z. et al. “Poly(ethyl α-cyanoacrylate)-Based Artificial Solid Electrolyte Interphase Layer for Enhanced Interface Stability of Li Metal Anodes” 2017, Chemistry of Materials, Vol. 29, pp. 4682-4689, US20050042515A1, and EP3136475A1). Besides, EP3093906A1 and EP3109924A1 disclose that the inclusion of certain inorganic particles on polyvinyl alcohol polymer or copolymer protection films may have an effect on mechanical properties and on the formation of dendrites on the surface of a lithium metal electrode.

Nevertheless, there is still a need to achieve better performances of lithium batteries, particularly to obtain protected lithium anodes with improved Coulombic efficiency and cycle-life.

In view of what is described above, new coating for protecting lithium-metal anodes featuring improved capacity and reversibility would represent a huge step forward in the development of next-generation energy storage devices.

### SUMMARY OF INVENTION

The inventors have found that the incorporation of a specific amount of at least one inorganic particle having a specific average diameter and being selected from the group consisting of Al₂O₃, SiO₂, TiO₂, ZnO, Fe₂O₃, CuO y BaTiO₃, silicates, aluminosilicates, and borosilicates in a specific polymer coating forming a protective film of a certain thickness on a lithium anode, the coating being exempt of any nitrogen-containing additive such as LiNO₃ or of another metal salt such as LiTFSI, unexpectedly, allows to reach equally good battery performances in terms of Coulombic efficiency than protective coatings containing the mentioned nitrogen-containing additives. Particularly, a battery comprising the mentioned protected anode has improved Coulombic efficiency and cycle-life even in conditions where dendrite growth is avoided.

As used herein, in Li—S technology, the conditions where dendrite growth is avoided are such that low charge/discharge rates are used. A low charge/discharge rate is considered to be either at a rate below 2 C such as at 1.0, 0.5, 0.2, or 0.1, where C is the specific capacity of sulfur (1672 mAh/gS), or at current densities below 1 mA/cm² such as at 0.75, 0.5, or 0.25 mA/cm².

Thus, a first aspect of the invention relates to a protected anode for a lithium metal battery comprising:
a lithium metal anode; and
a protective monolayer disposed on at least a portion of the lithium metal anode,

wherein the protective monolayer consists of:
a polymer selected from the group consisting of a polyethylene oxide (PEO) based polymer, a crosslinked PEO based polymer (i.e. a PEO based polymer deriving from a polyethylene oxide based polymer having a cross-linking functional group), polymethylmethacrylate, polymethylacrylate, polyethylmethacrylate, polyethylacrylate, polypropylmethacrylate, polypropylacrylate, polybutylacrylate, polybutylmethacrylate, polypentylmethacrylate, polypentylacrylate, polycyclohexylmethacrylate, polycyclohexylacrylate, polyhexylmethacrylate, polyhexylacrylate, polyglycidylacrylate, polyglycidylmethacrylate, poly-2-ethylhexylmethacrylate, poly(decyl acrylate), polyethylene vinyl acetate, polyvinylidene fluoride, polyethylene oxide, polypropylene oxide, polystyrene, polystyrene sulfonate, hydrogenated polystyrene, polyvinylpyridine, polyvinyl cyclohexane, polyimide, polyamine, polyamide, polyethylene, polybutylene, polypropylene, poly(4-methyl-pentene), poly(butylene terephthalate), poly(isobutyl methacrylate), poly(ethylene terephthalate), polydimethylsiloxane, polydimethylsiloxane vinyl terminated, poly (C1 to C20 alkyl carbonate), polymaleic acid, poly(maleic anhydride), polymethacrylic acid, poly(tert-butyl vinyl ether), poly(cyclohexyl vinyl ether), polydivinylbenzene, polyacrylic acid, polymethacrylic acid, polynitrile, polyphosphazine, polydiene, polyisoprene, polybutadiene, polychloroprene, polyisobutylene, polyurethane, polybenzimidazole, polypyrrole, and copolymers thereof; and
at least one inorganic particle selected from the group consisting of Al₂O₃, MnO, MnO₂, SiO₂, TiO₂, ZnO, ZrO₂, Fe₂O₃, CuO, a silicate, an aluminosilicate, a borosilicate, and an oxysalt of formula AₓB_{y}O_{z} wherein A is an alkaline metal or an alkaline-earth metal, B is selected from the group consisting of Al, Mn, Si, Ti, Zn, Zr, Fe, and Cu, and x, y, z, are the number of the corresponding atoms so that the overall charge of the oxysalt is 0, such as BaTiO₃, or any one of the mentioned inorganic particles which are functionalized;

and wherein:

the protective monolayer has a thickness from 0.01 to 10 μm;

the inorganic particles have an average diameter from 1 to 500 nm; and

the at least one inorganic particle is in an amount from 0.01 to 30 wt %.

Surprisingly, as can be seen from the examples and comparative examples, batteries comprising the protected lithium metal anodes as defined above show a surprisingly good Coulombic efficiency, and cycle-life in conditions where dendrite growth is avoided. Unexpectedly, in spite of the protecting coating being exempt of any nitrogen-containing additive such as LiNO₃ or of another metal salt such as LiTFSI, the improvement on the Coulombic efficiency is maintained above 99% for at least 120 cycles.

A second aspect of the invention relates to a process for the preparation of a lithium metal protected anode as defined above, the process comprising:
a) forming a precursor solution or dispersion by either dissolving or dispersing
   a polymer selected from the group consisting of a PEO based polymer, a PEO based polymer having a cross-linking functional group, polymethylmethacrylate, polymethylacrylate, polyethylmethacrylate, polyethylacrylate, polypropylmethacrylate, polypropylacrylate, polybutylacrylate, polybutylmethacrylate, polypentylmethacrylate, polypentylacrylate, polycyclohexylmethacrylate, polycyclohexylacrylate, polyhexylmethacrylate, polyhexylacrylate, polyglycidylacrylate, polyglycidylmethacrylate, poly-2-ethylhexylmethacrylate, poly(decyl acrylate), polyethylene vinyl acetate, polyvinylidene fluoride, polyethylene oxide, polypropylene oxide, polystyrene, polystyrene sulfonate, hydrogenated polystyrene, polyvinylpyridine, polyvinyl cyclohexane, polyimide, polyamine, polyamide, polyethylene, polybutylene, polypropylene, poly(4-methyl-pentene), poly(butylene terephthalate), poly(isobutyl methacrylate), poly(ethylene terephthalate), polydimethylsiloxane, polydimethylsiloxane vinyl terminated, poly (C1 to C20 alkyl carbonate), polymaleic acid, poly(maleic anhydride), polymethacrylic acid, poly(tert-butyl vinyl ether), poly(cyclohexyl vinyl ether), polydivinylbenzene, polyacrylic acid, polymethacrylic acid, polynitrile, polyphosphazine, polydiene, polyisoprene, polybutadiene, polychloroprene, polyisobutylene, polyurethane, polybenzimidazole, polypyrrole, and copolymers thereof; and
   at least one inorganic particle selected from the group consisting of Al₂O₃, MnO, MnO₂, SiO₂, TiO₂, ZnO, ZrO₂, Fe₂O₃, CuO, a silicate, an aluminosilicate, a borosilicate, and an oxysalt of formula AₓB_{y}O_{z} wherein A is an alkaline metal or an alkaline-earth metal, B is selected from the group consisting of Al, Mn, Si, Ti, Zn, Zr, Fe, and Cu, and x, y, z, are the number of the corresponding atoms so that the overall charge of the oxysalt is 0, such as BaTiO₃, or any one of the mentioned inorganic particles which are functionalized;
in an anhydrous solvent,
wherein the at least one inorganic particle is in an amount from 0.01 to 30 wt % related to the amount of polymer;
b) spreading the precursor solution or dispersion obtained in step a) onto a lithium metal anode; and
c) evaporating the solvent and optionally carrying out a crosslinking reaction in order to form a continuous, optionally cross-linked, film over the lithium metal anode.

A third aspect of the invention relates to a lithium metal battery comprising:
a) a protected anode as defined herein above or below;
b) a cathode; and
c) a suitable electrolyte interposed between the cathode and the anode.

Finally, a fourth aspect of the invention relates to the use of the lithium metal protected anode as defined above to improve Coulombic efficiency of a lithium battery, particularly in conditions where dendritic growth is avoided.

### BRIEF DESCRIPTION OF DRAWINGS

FIG. 1 depicts the schematic process of Li protecting coating formation procedure, comprising the following steps: 1) a lithium foil is placed on a coin cell back container; 2) a coating precursor solution is added; and 3) the system is annealed by promoting the solvent evaporation to induce polymer cross linking and SEI formation.

FIG. 2a shows FE-SEM micrographs of films (coating “C”) on glassy SnO₂:F (substrate “S”) as a rigid substrate obtained from different precursor concentrations. The method reproduced on a Li foil allowed to obtain the continuous coating shown in FIG. 2b.

FIG. 3 depicts the Coulombic efficiency results of cells containing a Li anode without any treatment (Standard); a Li anode treated with PEGDA at 2.0 wt % to form a film of ˜200 nm (PEGDA); and Li anodes treated with a 2.0 wt % PEGDA solution in combination with 10 mM LiTFSI (PEGDA+LiTFSI), with 50 mM LiNO₃ (PEGDA+LiNO₃), with a 2.4 wt % of alumina (PEGDA+Al₂O₃), with 50 mM LiNO₃ and 10 mM LiTFSI (PEGDA+LiNO₃+LiTFSI), with 50 mM LiNO₃ and 2.4 wt % of alumina (PEGDA+LiNO₃+Al₂O₃), or with 50 mM LiNO₃ in combination with 10 mM LiTFSI and 2.4 wt % of alumina (PEGDA+LiNO₃+LiTFSI+Al₂O₃).

FIG. 4 depicts the Coulombic efficiency results of cells containing a Li anode without any treatment (Standard); and Li anodes treated with a 2.0 wt % PEGDA solution in combination with either a 2.4 wt % of alumina (PEGDA+Al₂O₃ 2.4%) or a 20 wt % of alumina (PEGDA+Al₂O₃ 20%).

FIG. 5 depicts the Coulombic efficiency results of cells containing a Li anode without any treatment (Standard); and Li anodes treated with a 2.0 wt % PEGDA solution in combination with either a 2.4 wt % of MnO₂ (PEGDA+MnO₂ 2.4%), a 20 wt % of MnO₂ (PEGDA+MnO₂ 20%), or a 60 wt % of MnO₂ (PEGDA+MnO₂ 60%).

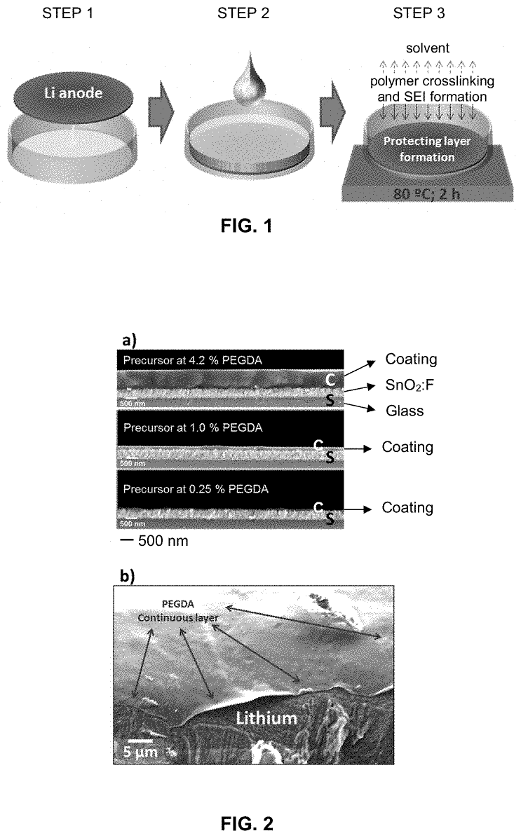

### DETAILED DESCRIPTION OF THE INVENTION

For the sake of understanding, the following definitions are included and expected to be applied throughout the description, claims and drawings.

In this specification, “(meth)acrylate” is used as a general term representing “acrylate” and “methacrylate”.

The terms “particle size”, as used herein, is in terms of diameter irrespective of the actual particle shape. The term “diameter”, as used herein, means the equivalent sphere diameter, namely the diameter of a sphere having the same diffraction pattern, when measured by laser diffraction, as the particle. The diameter of nanoparticles can be measured by Transmission Electron Microscopy (TEM). TEM measurements can be performed on JEOL 2010 F operating with 200 kV accelerating voltage. The characterization of nanoparticles can be made by deposition of a drop of highly diluted (0.1 mg/ml) nanoparticle dispersion in heptane onto a formvar coated grid, stabilized with evaporated carbon film, FCF300-Cu-25 grid from Electron Microscopy Science. The sizes of pitch, hole and bar are 84, 61, 23 μm, respectively (300 mesh). Average size and size distribution can be calculated by measuring the dimensions of a representative amount of nanoparticles by this technique. Image processing software packages are used to quantify particle size and size distribution. An example of such a software is Pebbles (cf. S. Mondini, et al., “PEBBLES and PEBBLEJUGGLER: software for accurate, unbiased, and fast measurement and analysis of nanoparticle morphology from transmission electron microscopy (TEM) micrographs”, Nanoscale, 2012, 4, 5356-5372).

All percentages used herein are by weight of the total composition, unless otherwise designated.

As used herein, the indefinite articles “a” and “an” are synonymous with “at least one” or “one or more.” Unless indicated otherwise, definite articles used herein, such as “the,” also include the plural of the noun.

As mentioned above, a first aspect relates to a protected anode for a lithium metal battery, the anode comprising a lithium metal anode and a protective monolayer disposed on at least a portion of the lithium metal anode, wherein the protective monolayer consist of one polymer and at least one inorganic particle is as defined herein above and below.

Also as mentioned above, a second aspect of the invention relates to a process for the preparation of the protected lithium metal anode as defined above, the process comprising forming a precursor solution or dispersion as defined above; spreading it onto the lithium metal anode; and evaporating the solvent and, optionally, carrying out a crosslinking reaction, in order to form a continuous, optionally cross-linked, film over the lithium metal anode.

### Film Precursor Solution

The precursor solution or dispersion used to form the film coating on the surface of the lithium metal anode is obtained by dissolving or dispersing a polymer as defined herein above or below and at least one inorganic particle as defined herein above or below in an anhydrous solvent.

### The Polymer

As mentioned above, polymers useful for obtaining the coated lithium anode of the invention are a polyethylene oxide (PEO) based polymer, a PEO based polymer having a cross-linking functional group, polymethylmethacrylate, polymethylacrylate, polyethylmethacrylate, polyethylacrylate, polypropylmethacrylate, polypropylacrylate, polybutylacrylate, polybutylmethacrylate, polypentylmethacrylate, polypentylacrylate, polycyclohexylmethacrylate, polycyclohexylacrylate, polyhexylmethacrylate, polyhexylacrylate, polyglycidylacrylate, polyglycidylmethacrylate, poly-2-ethylhexylmethacrylate, poly(decyl acrylate), polyethylene vinyl acetate, polyvinylidene fluoride, polyethylene oxide, polypropylene oxide, polystyrene, polystyrene sulfonate, hydrogenated polystyrene, polyvinylpyridine, polyvinyl cyclohexane, polyimide, polyamine, polyamide, polyethylene, polybutylene, polypropylene, poly(4-methyl-pentene), poly(butylene terephthalate), poly(isobutyl methacrylate), poly(ethylene terephthalate), polydimethylsiloxane, polydimethylsiloxane vinyl terminated, poly(C1 to C20 alkyl carbonate) polymaleic acid, poly(maleic anhydride), polymethacrylic acid, poly(tert-butyl vinyl ether), poly(cyclohexyl vinyl ether), polydivinylbenzene, polyacrylic acid, polymethacrylic acid, polynitrile, polyphosphazine, polydiene, polyisoprene, polybutadiene, polychloroprene, polyisobutylene, polyurethane, polybenzimidazole, polypyrrole, and copolymers thereof. These polymers are commercially available.

Particularly, PEO is an attractive building block material to form thin films on Li anodes. Due to its intrinsic ionic conductivity, the permeation of Li ions through PEO barrier is allowed while the electrolyte degradation is suppressed as the PEO interface prevents the contact between the solvent and the Li metal.

Besides, material engineering permits the modification of PEO to add functional groups that leads to the formation of a tri-dimensional net through different cross-linking chemistries. Consequently, an insoluble and mechanically stable coating can be formed which blocks the dendrite growth and homogenizes Li platting. Thus, a PEO based polymer having cross-linking functional groups comprised in the precursor solution will form a tri-dimensional matrix. The versatility of PEO based polymers can be used to design advanced materials adjusted to competitive processing methods and/or with additional functionalities (e.g. polymeric ionic liquid nature).

Thus, in a particular embodiment, the polymer is a PEO based polymer, or a crosslinked PEO based polymer. Particularly, the polymer is a PEO based polymer having a meth(acrylate) or a vinyl functional group, more particularly the polymer is poly(ethylene glycol) diacrylate (PEGDA), or poly(ethylene glycol) dimethacrylate (PEGDMA).

The cross-linking reaction necessary to obtain the final crosslinked PEO based polymer can take place through the following mechanism:
1) chain-growth polymerization by radical polymerization of, for example, meth(acrylate) or vinyl groups containing PEO chains;
2) step-growth polymerization with PEO chains having complementary functional groups capable to induce either addition/condensation reactions, or nucleophilic substitution reactions.

Thus, in a particular embodiment of the lithium metal anode of the invention, the polymer is a crosslinked PEO based polymer deriving from a PEO based polymer having a cross-linking functional group selected from the group consisting of meth(acrylate), vinyl, a functional group capable to induce an addition or a condensation reaction, and a functional group capable to induce a nucleophilic substitution reaction.

Particularly, examples of groups capable to induce addition/condensation reactions are a carboxylic acid group and an alcohol group, or an isocyanate group and an alcohol group. Examples of groups capable to induce nucleophilic substitution reactions are an (C₁-C₄)alkyl tosylate and an amine, or halogen atom such as Cl, Br or I and amine.

In a more particular embodiment of the lithium metal anode of the invention, the crosslinked PEO based polymer derives from poly(ethylene glycol) diacrylate (PEGDA), poly(ethylene glycol) dimethacrylate (PEGDMA), di(N,N′-vinyl imidazolium) dianion terminated poly(ethylenoxide), and tosylate terminated poly(ethylenoxide).

The mentioned PEO based polymers or PEO based polymers having cross-linking functional groups are used in a particular embodiment of the process of the invention.

In another particular embodiment, the PEO based polymer is PEGDA, particularly of a MW of PEG unit from 214 to 2326 g/mol (n=2-50), more particularly of 550 (n=10).

In another particular embodiment, the PEO based polymer having a cross-linking functional group is a PEO-based polymeric ionic liquid, which allows adjusting the properties and optimize the protective performance (by improving properties such as ionic conductivity, hydrophobic nature, and inorganic/carbon materials dispersion capability) of the coated Li anode in LMB. Examples of PEO-based polymeric ionic liquids include, without being limited to, di(N,N′-vinyl imidazolium) dianion terminated poly(ethylenoxide), and tosylate terminated poly(ethylenoxide).

PEO derivatives with radical cross-linking groups are sensitive to oxygen as they act as radical scavengers. Therefore, particularly the film formation process can be carried out in a glove box under oxygen and moisture free atmosphere (O₂<0.1 ppm and H₂O<0.1 ppm). As a result, solvent is evaporated leaving a continuous, crosslinked film with a controlled thickness.

### Inorganic Particles

The inorganic particles are selected from the group consisting of Al₂O₃, MnO, MnO₂, SiO₂, TiO₂, ZnO, ZrO₂, Fe₂O₃, CuO, a silicate, an aluminosilicate, a borosilicate, and an oxysalt of formula AₓB_{y}O_{z} wherein A is an alkaline metal or an alkaline-earth metal, B is selected from the group consisting of Al, Mn, Si, Ti, Zn, Zr, Fe, and Cu, and x, y, z, are the number of the corresponding atoms so that the overall charge of the oxysalt is 0, such as BaTiO₃, or any one of the mentioned inorganic particles which are functionalized. Unexpectedly, these inorganic particles in addition to increase the mechanical stability of the polymeric film protecting the anode (e.g. by formation of composites), allow obtaining a battery with improved Coulombic efficiency, and cycle-life in conditions where dendrite growth is avoided.

As mentioned above, the inorganic particles are nanoparticles having an average diameter from 1 to 500 nm. In a particular embodiment of the protected anode of the invention, optionally in combination with one or more features of the particular embodiments defined above, the inorganic particles have an average diameter from 1 to 100 nm, more particularly from 1 to 10 nm. Also particularly, they have a sharp particle size distribution.

The inorganic particles are commercially available, also within the mentioned particle size ranges. Additionally, inorganic particles within the mentioned particle size range can be obtained by known mechanical methods, such as milling and/or sieving or chemical methods, such as precipitation, metal evaporation, laser pyrolysis, gas phase methods and plasma-chemical reduction method. In a particular case, metal oxide nanoparticles with controlled size and shape can be synthesized by adding basic solutions (KOH, NaOH) into a metallic salt precursor solution in the required concentrations to obtain the desired dimensions. Depending on the metal cation, metal oxide nanoparticles can be obtained directly. However, in some cases further annealing treatment is required to induce the transitions from the formed phase into the metal oxide nanoparticle. These methods are widely known and use commonly available equipment.

In a particular embodiment, optionally in combination with one or more features of the particular embodiments defined above, the inorganic particle is Al₂O₃.

In another particular embodiment, optionally in combination with one or more features of the particular embodiments defined above, the inorganic particles are silicates, aluminosilicates, and borosilicates. Particularly, the silicate has the formula SiₐO_{b}, the aluminosilicate is a mixture of SiₐO_{b} and Al₂O₃, and the borosilicate is a mixture of SiₐO_{b} and B₂O₃, wherein a=1-4 and b=2-8.

Although bare nanoparticles can be added, inorganic particles functionalized with molecules containing groups that can be covalently linked to the polymeric matrix are capable of being anchored to this polymeric matrix, which prevent their loss in the electrolyte. In such a way, functionalized inorganic particles are integrated in the polymer matrix to form a composite. Thus, in another particular embodiment of the process of the invention, optionally in combination with one or more features of the particular embodiments defined above, the inorganic particle is a functionalized inorganic particle. Particularly, the inorganic particle is a functionalized Al₂O₃.

The nanoparticles can be functionalized by anchoring different organic compounds on their surface, in order to gain additional physicochemical properties such as improved dispersability and conductivity.

The anchoring takes place, usually but not limited to, through covalent bonding created between the metal oxide and certain groups such as silane or phosphonate groups, which are part of the organic molecule (cf. M. A. Neouze and U. Schubert “Surface Modification and Functionalization of Metal and Metal Oxide Nanoparticles by Organic Ligands” Monatsh Chem, 2008, Vol. 139, pp. 183-195). Examples of typical routes to functionalize nanoparticles lie on the dissolution of the organic compound into a solvent, disperse the nanoparticles into the solution and keep the system stirring for a certain time to let the surface of the nanoparticle be coated by the organic molecule. The process may require further procedures such as filtering, purification and/or temperature treatments to obtain the final purified product. The functionalization of nanoparticles is not limited to the described procedure as different routes can be found in the state of art (cf. E. Hogue et al. “Alkylphosphonate Modified Aluminum Oxide Surfaces” J. Phys. Chem. B 2006, Vol. 110, pp. 10855-10861; P. H. Mutin et al. “Hybrid materials from organophosphorus coupling molecules” J. Mater. Chem., 2005, Vol. 15, pp. 3761-3768).

As mentioned above, the amount of inorganic particles in the polymer is from 0.01 to 30 wt %. In a particular embodiment of the anode of the invention, optionally in combination with one or more features of the particular embodiments defined above, the amount of the at least one inorganic particle in the protective layer is from 0.01 to 20 wt %, or from 0.1 to 20 wt %, or from 0.5 to 20 wt %, or from 1 to 10 wt %, or from 1.5 to 5 wt %, related to the amount of polymer.

Accordingly, as the mentioned inorganic particles can also form part of the precursor solution or dispersion used in the process for the preparation of the anode of the invention, the above mentioned amounts of particles, particle sizes, and particular inorganic particles also define particular embodiments of the process of the invention, optionally in combination with one or more features of the particular embodiments of the process defined above.

In another particular embodiment, optionally in combination with one or more features of the particular embodiments of the process defined above, the polymer is poly(ethylenoxide)diacrylate (PEGDA) and the at least one inorganic particle is in an amount from 2 to 20 wt %, or from 2 to 5 wt %, more particularly of 2.4 wt %.

### Anhydrous Solvent

As mentioned above, the precursor solution or dispersion is obtained by dissolving or dispersing the polymer and the at least one inorganic particle in the amounts defined above in an anhydrous solvent.

Examples of solvents include, without being limited to, dimethoxyethane (DME), dethylenglycol dimethylether (DEGDME), 1,3-dioxolane (DOL), and 1,4-dioxane. The evaporation can be carried out at room temperature or at higher temperature.

The specific combination of components forming the protective coating defined above provides an efficient and optimized Li protection, that allows obtaining a lithium metal battery having an improved Coulombic efficiency, and cycle-life in conditions where dendrite growth is avoided (low charge/discharge rates used in Li—S technology).

Field emission scanning electron microscope (FE-SEM) characterization was used to find out the correlation between the polymer concentration in the precursor solution and the thickness of the formed film. Particularly, the thickness of the film at each measurement point may be measured through observation of a cross-sectional view of the coated anode by using a FE-SEM (e.g., ULTRA plus ZEISS field emission scanning electron microscope).

As mentioned above, the protective monolayer has a thickness from 0.01 to 10 μm. In a particular embodiment of the protected anode of the invention, optionally in combination with one or more features of the particular embodiments defined above, the protective monolayer has a thickness from 0.05 to 5 μm, or from 0.1 to 1 μm.

Accordingly, in a particular embodiment of the process of the invention, optionally in combination with one or more features of the particular embodiments defined above, in the precursor solution or dispersion used to form the film coating on the surface of the lithium metal anode, the concentration of the polymer, particularly of the polyethylene oxide based polymer optionally comprising cross-linking functional groups, is from 0.1 to weight % with respect to the mass of the precursor solution.

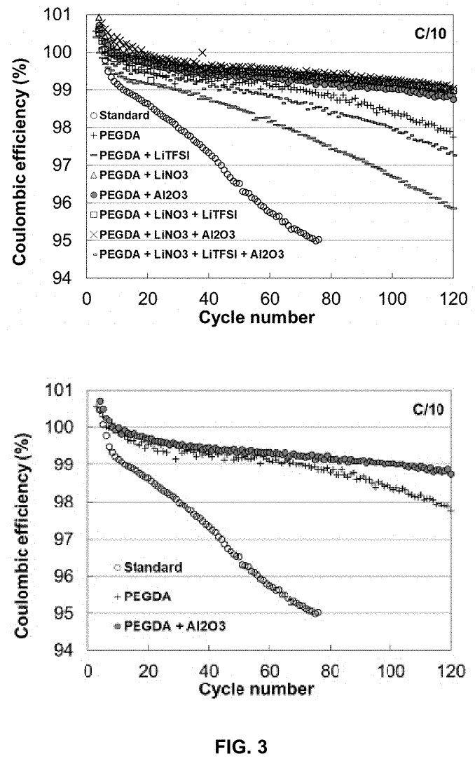

Thus, as an instance, PEGDA concentration above 1 wt % with respect to the mass of the precursor solution, allows obtaining a continuous and homogeneous film of ˜100 nm whereas thicker films of ˜400 nm are obtained from 4.2% concentration solutions (see FIG. 3, particularly FIG. 3b as an example of the preparation of an uniform and continuous PEGDA film on a Li anode).

An anode obtainable by the process mentioned above also forms part of the invention.

The anode as defined above can be used in the manufacture of a lithium battery. Thus, also form part of the invention a lithium battery comprising a lithium metal anode as defined herein above, a cathode, and an electrolyte interposed between the cathode and the anode. Particularly, the cathode comprises sulfur.

The lithium battery also comprises an electrolyte. Such electrolytes include a salt and a solvent.

As a way of example, electrolytes for Li-sulfur batteries may contain lithium salts and organic solvents. Some of the most widely used solvents are ethers such as poly(ethylene glycol), 1,3-dioxolane (DOL), 1,2-dimethoxyethane (DME) or tetra(ethylene glycol) dimethyl ether (TEGDME). Examples of the lithium salts are LiCF₃SO₃ (also known as LiTfO), Li(CF₃SO₂)₂N (also known as LiTFSI), and LiNO₃, among others. In yet other embodiments, the electrolyte comprises a lithium salt and an ionic liquid, such as the lithium salt LiTFSI together with the IL (N-methyl-N-propylpyrrolidone)TFSI.

When in the battery, the lithium metal anode may absorb components of the electrolyte. Thus, in a particular embodiment of the battery of the invention, the protective monolayer further comprises one or more components of the electrolyte capable of diffusing to the protective monolayer in an amount up to 2 wt %, up to 1.5 wt %, up to 1 wt %, or up to 0.5 wt %, with respect to the amount of polymer, wherein the component of the electrolyte capable of diffusing to the protective monolayer is selected from an organic solvent, a lithium salt, an ionic liquid, and mixtures thereof. Particularly, the component of the electrolyte capable of diffusing to the protective monolayer is a mixture of a lithium salt as defined above and a solvent, more particularly, a lithium salt as defined above.

Throughout the description and claims the word “comprise” and variations of the word, are not intended to exclude other technical features, additives, components, or steps.

Furthermore, the word “comprise” encompasses the case of “consisting of”. Additional objects, advantages and features of the invention will become apparent to those skilled in the art upon examination of the description or may be learned by practice of the invention. The following examples and drawings are provided by way of illustration, and they are not intended to be limiting of the present invention. Reference signs related to drawings and placed in parentheses in a claim, are solely for attempting to increase the intelligibility of the claim, and shall not be construed as limiting the scope of the claim. Furthermore, the present invention covers all possible combinations of particular and preferred embodiments described herein.

### EXAMPLES

### A) Materials and Equipment

Battery grade 1,3-dioxolane (DOL) and 1,2-dimethoxyethane (DME) were purchased from BASF and further purified with molecular sieves 3A sigma Aldrich to keep moisture content below 20 ppm. The water content was measured by a Karl Fischer TitroLine KF Trace equipment from Schott Instruments using Hydranal-Coulomat AG reactant. It must be noted that the molecular sieves were rinsed with acetone several times and subsequently annealed at 200° C. for 6 h, previously to their use.

Lithium bis(trifluoromethanesulfonyl)imide (LiTFSI) was purchased from Solvionic>99%); Lithium nitrate (LiNO₃) from Aldrich 99.99%; alumina nanoparticles, 5 nm 99.99%, from US Research Nanoparticles Inc.; and poly(ethylene glycol) diacrylate 550 g/mol from Sigma-Aldrich.

### B) Experimental

### 1. Cathode Preparation

For the preparation of the cathode composite, elemental sulfur (Sigma-Aldrich, 100-mesh particle size) and carbon black (Ketjenblack EC-600JD, AkzoNobel) were ball milled (Restch, PM100) for 3 h at 300 rpm. The mixture was heated at 150° C. for 6 h under argon atmosphere. Then, the temperature was increased to 300° C. and kept for 3 h to vaporize the superfluous sulfur on the outer surface of carbon spheres, diffusing entirely into the pores. After cooling down to room temperature, the sulfur-carbon composite was obtained.

Cathode was prepared by mixing sulfur-carbon composite, conductive carbon black (Super C45, Timcal) and polyvinylidene fluoride (PVDF, BASF) in a weight ratio of 50:40:10 and using N-methylpyrrolidone (NMP, Sigma-Aldrich) as solvent. The resultant slurry was cast onto carbon coated aluminum foil using the doctor blade and dried at 60° C. for 2h. The loading of the cathode was 1.60±0.05 mg_{sulfur}·cm⁻².

Cycle life of the coin cells was investigated within 1.7 V-2.6 V vs Li/Li⁺ at 0.1 C (1 C=1,672 mA/gS) using a battery cycler Basytec CTS system (BASYTEC GMBH, Germany) at 25° C.

### 2. Electrolyte Preparation

The electrolyte consisted of a solution of [LiTFSI] at 0.38 M and [LiNO₃] at 0.32 M in DOL:DME solvent mixture at 1:1 volume ratio.

### 3. Li Anode Protection

The coating of Li anode was performed by using a precursor solution in DME of the required elements:
PEGDA at 2 wt % based on full solution weight;
LiTFSI at 0.02 M based on DOL:DME solvent volume;
LiNO₃ at 0.05 M based on DOL:DME solvent volume;
Al₂O₃ at 2.4 wt % or 20 wt % with respect to polymer; and
MnO₂ at 2.4 wt % or 20 wt % with respect to polymer.

Lithium foil anode of 2.6 cm² area was placed on the case of the coin cell. Subsequently, 100 μL of the precursor solution was spread over the Li anode and solvent evaporation let to dry.

### C) Electrochemical Characterization

The electrochemical characterization was carried out assembling CR2025 type coin cells (Hohsen Corp.) in a dry room. As the negative electrode (Anode) lithium foil (50 μm thickness, Rockwood lithium) was used (Li anode could contain a protective coating generated as previously explained), a polyethylene based separator, a positive electrode (cathode) prepared as previously explained and adding 50 μL of electrolyte.

For each system, three coin cells were tested in order to ensure the reproducibility of the approach.

### Examples 1 and 2

Coatings on Li foils were obtained according to the “Li anode protection” disclosed above.

For each precursor solution the concentration of the corresponding components are indicated.

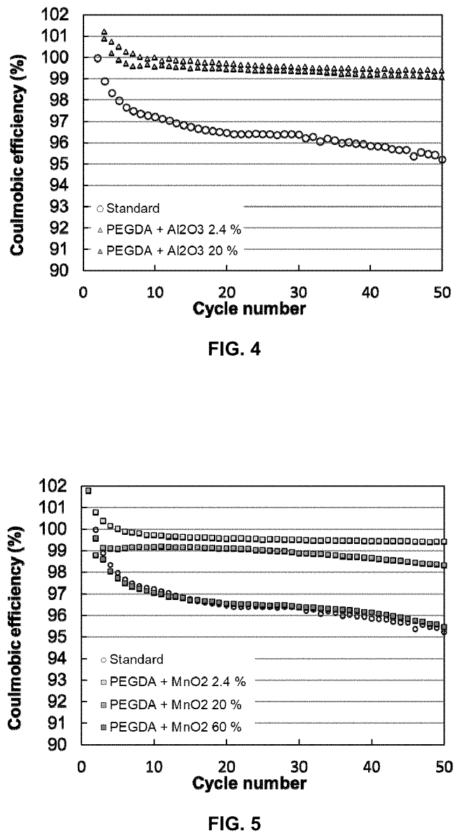

The Coulombic efficiency of cells containing an anode:
a) treated with PEGDA at 2.0 wt % and 2.4 wt % alumina (PEGDA+Al₂O₃; Example 1);
b) treated with PEGDA at 2.0 wt % and 20 wt % alumina (PEGDA+Al₂O₃; Example 2) was tested (see FIG. 4).

The thickness of the films formed from a precursor solution with a PEGDA concentration of a 2.0 wt % with respect to the mass of the precursor solution was of ˜200 nm.

### Examples 3 and 4

Coatings on Li foils were obtained according to the “Li anode protection” disclosed above. For each precursor solution the concentration of the corresponding components are indicated.

The Coulombic efficiency of cells containing an anode:
a) treated with PEGDA at 2.0 wt % and 2.4 wt % MnO₂ (PEGDA+MnO₂; Example 3);
b) treated with PEGDA at 2.0 wt % and 20 wt % MnO₂ (PEGDA+MnO₂; Example 4) was tested (see FIG. 5).

The thickness of the films formed from a precursor solution with a PEGDA concentration of a 2.0 wt % with respect to the mass of the precursor solution was of ˜200 nm.

### Comparative Examples 1-7

Similarly as in Examples 1 and 2, the Coulombic efficiency of cells containing an anode:
a) without any treatment (standard, STD; Comparative Example 1);
b) treated with PEGDA precursor at 2.0 wt %, (PEGDA; Comparative Example 2);
c) treated with PEGDA at 2.0 wt % and 10 mM LiTFSI (PEGDA+LiTFSI; Comparative Example 3);
d) treated with PEGDA at 2.0 wt % and 50 mM LiNO₃ (PEGDA+LiNO₃; Comparative Example 4);
f) treated with PEGDA at 2.0 wt %, 50 mM LiNO₃ and 10 mM LiTFSI (PEGDA+LiNO₃+LiTFSI; Comparative Example 5); and
g) treated with PEGDA at 2.0 wt %, 50 mM LiNO₃, 10 mM LiTFSI, and 2.4 wt % Al₂O₃ (PEGDA+LiNO₃+LiTFSI+Al₂O₃; Comparative Example 6); and
h) treated with PEGDA at 2.0 wt % and 60 wt % MnO₂ (PEGDA+MnO₂; Comparative Example 7)
   was also tested.

The thickness of the formed films was of ˜200 nm.

As it can be inferred from FIG. 4 and FIG. 5, the treatment of Li anode with any of the protecting coatings assayed is beneficial compared to the unprotected anode (standard). As expected, the results with Al₂O₃ and with MnO₂ was similar for the same content of the inorganic particle.

The treatment of Li with PEGDA leads to higher values of Coulombic efficiency in comparison with the standard system. However, the system with PEGDA film suffers from a rapid efficiency decrease, which implies a poor robustness.

The combination of PEGDA and LiTFSI had not a particularly good performance, but showed a worst performance than the PEGDA system. Additionally, the performance of the quaternary system consisting of PEGDA, LiNO₃, LiTFSI and Al₂O₃ was substantially inefficient as Li anode protection.

The systems of PEGDA plus LiNO₃ and, optionally, LiTFSI allowed obtaining Li protection coatings with improved Coulombic efficiency with respect to the PEGDA cell. With regard to the performance of the PEGDA plus LiNO₃ and LiTFSI system, it is not evident to justify its improvement, as primary results in binary PEGDA-LiTFSI system did not show any outstanding performance.

Unexpectedly, the behavior of PEGDA-Al₂O₃ is similar to PEGDA-LiNO₃, and the incorporation of an amount of inorganic particles higher to the claimed range lead to a result similar to the unprotected anode (standard), i.e. no beneficial effect is observed.

### CITATION LIST

### Patent Literature

1. US20050042515A1;
2. EP3136475A1;
3. EP3093906A1;
4. EP3109924A1

### Non Patent Literature

1. Zhang, S. S., “Role of LiNO₃ in rechargeable lithium/sulfur battery” Electrochim. Acta, 2012, Vol. 70, p. 344-348;
2. Hu Z. et al. “Poly(ethyl α-cyanoacrylate)-Based Artificial Solid Electrolyte Interphase Layer for Enhanced Interface Stability of Li Metal Anodes” 2017, Chemistry of Materials, Vol. 29, pp. 4682-4689;
3. M. A. Neouze and U. Schubert “Surface Modification and Functionalization of Metal and Metal Oxide Nanoparticles by Organic Ligands” Monatsh Chem, 2008, Vol. 139, pp. 183-195;
4. E. Hogue et al. “Alkylphosphonate Modified Aluminum Oxide Surfaces” J. Phys. Chem. B 2006, Vol. 110, pp. 10855-10861;
5. P. H. Mutin et al. “Hybrid materials from organophosphorus coupling molecules” J. Mater. Chem., 2005, Vol. 15, pp. 3761-3768.

1. A protected anode for a lithium metal battery comprising:
a lithium metal anode; and
a protective monolayer disposed on at least a portion of the lithium metal anode,
wherein the protective monolayer consists of
a polymer selected from the group consisting of a polyethylene oxide (PEO) based polymer, a crosslinked PEO based polymer, polymethylmethacrylate, polymethylacrylate, polyethylmethacrylate, polyethylacrylate, polypropylmethacrylate, polypropylacrylate, polybutylacrylate, polybutylmethacrylate, polypentylmethacrylate, polypentylacrylate, polycyclohexylmethacrylate, polycyclohexylacrylate, polyhexylmethacrylate, polyhexylacrylate, polyglycidylacrylate, polyglycidylmethacrylate, poly-2-ethylhexylmethacrylate, poly(decyl acrylate), polyethylene vinyl acetate, polyvinylidene fluoride, polyethylene oxide, polypropylene oxide, polystyrene, polystyrene sulfonate, hydrogenated polystyrene, polyvinylpyridine, polyvinyl cyclohexane, polyimide, polyamine, polyamide, polyethylene, polybutylene, polypropylene, poly(4-methyl-pentene), poly(butylene terephthalate), poly(isobutyl methacrylate), poly(ethylene terephthalate), polydimethylsiloxane, polydimethylsiloxane vinyl terminated, poly (C1 to C20 alkyl carbonate), polymaleic acid, poly(maleic anhydride), polymethacrylic acid, poly(tert-butyl vinyl ether), poly(cyclohexyl vinyl ether), polydivinylbenzene, polyacrylic acid, polymethacrylic acid, polynitrile, polyphosphazine, polydiene, polyisoprene, polybutadiene, polychloroprene, polyisobutylene, polyurethane, polybenzimidazole, polypyrrole, and copolymers thereof; and
at least one inorganic particle selected from the group consisting of Al₂O₃, MnO, MnO₂, SiO₂, TiO₂, ZnO, ZrO₂, Fe₂O₃, CuO, a silicate, an aluminosilicate, a borosilicate, and an oxysalt of formula AₓB_{y}O_{z} wherein A is an alkaline metal or an alkaline-earth metal, B is selected from the group consisting of Al, Mn, Si, Ti, Zn, Zr, Fe, and Cu, and x, y, z, are the number of the corresponding atoms so that the overall charge of the oxysalt is 0, or any one of the mentioned inorganic particles which are functionalized;
and wherein:
the protective monolayer has a thickness from 0.01 to 10 μm;
the inorganic particles have an average diameter from 1 to 500 nm; and
the at least one inorganic particle is in an amount from 0.01 to 30 wt % related to the amount of polymer.

2. The protected anode according to claim 1, wherein the at least one inorganic particle is in an amount from 0.01 to 20 wt %, or from 0.1 to 20 wt %, or from 0.5 to 20 wt %, or from 1 to 10 wt %, or from 1.5 to 5 wt %, related to the amount of polymer.

3. The protected anode according to claim 1, wherein the polymer is a PEO based polymer, or a crosslinked PEO based polymer.

4. The protected anode according to claim 3, wherein the polymer is a PEO based polymer having a meth(acrylate) or a vinyl functional group.

5. The protected anode according to claim 4, wherein the polymer is poly(ethylene glycol) diacrylate (PEGDA), or poly(ethylene glycol) dimethacrylate (PEGDMA).

6. The protected anode according to claim 3, wherein the polymer is a crosslinked PEO based polymer deriving from a PEO based polymer having a cross-linking functional group selected from the group consisting of meth(acrylate), vinyl, a functional group capable to induce an addition or a condensation reaction, and a functional group capable to induce a nucleophilic substitution reaction.

7. The protected anode according to claim 6, wherein the PEO based polymer having a cross-linking functional group is selected from the group consisting of poly(ethylene glycol) diacrylate (PEGDA), poly(ethylene glycol) dimethacrylate (PEGDMA), di(N,N′-vinyl imidazolium) dianion terminated poly(ethylenoxide), and tosylate terminated poly(ethylenoxide).

8. The protected anode according to claim 1, wherein the inorganic particle is Al₂O₃.

9. The protected anode according to claim 1, wherein the inorganic particle is a functionalized Al₂O₃.

10. A process for the preparation of a lithium metal protected anode as defined in claim 1, the process comprising:
a) forming a precursor solution or a dispersion by either dissolving or dispersing
a polymer selected from the group consisting of a PEO based polymer, a PEO based polymer having a cross-linking functional group, polymethylmethacrylate, polymethylacrylate, polyethylmethacrylate, polyethylacrylate, polypropylmethacrylate, polypropylacrylate, polybutylacrylate, polybutylmethacrylate, polypentylmethacrylate, polypentylacrylate, polycyclohexylmethacrylate, polycyclohexylacrylate, polyhexylmethacrylate, polyhexylacrylate, polyglycidylacrylate, polyglycidylmethacrylate, poly-2-ethylhexylmethacrylate, poly(decyl acrylate), polyethylene vinyl acetate, polyvinylidene fluoride, polyethylene oxide, polypropylene oxide, polystyrene, polystyrene sulfonate, hydrogenated polystyrene, polyvinylpyridine, polyvinyl cyclohexane, polyimide, polyamine, polyamide, polyethylene, polybutylene, polypropylene, poly(4-methyl-pentene), poly(butylene terephthalate), poly(isobutyl methacrylate), poly(ethylene terephthalate), polydimethylsiloxane, polydimethylsiloxane vinyl terminated, poly (C1 to C20 alkyl carbonate), polymaleic acid, poly(maleic anhydride), polymethacrylic acid, poly(tert-butyl vinyl ether), poly(cyclohexyl vinyl ether), polydivinylbenzene, polyacrylic acid, polymethacrylic acid, polynitrile, polyphosphazine, polydiene, polyisoprene, polybutadiene, polychloroprene, polyisobutylene, polyurethane, polybenzimidazole, polypyrrole, and copolymers thereof; and
at least one inorganic particle selected from the group consisting of Al₂O₃, MnO, MnO₂, SiO₂, TiO₂, ZnO, ZrO₂, Fe₂O₃, CuO, a silicate, an aluminosilicate, a borosilicate, and an oxysalt of formula AₓB_{y}O_{z} wherein A is an alkaline metal or an alkaline-earth metal, B is selected from the group consisting of Al, Mn, Si, Ti, Zn, Zr, Fe, and Cu, and x, y, z, are the number of the corresponding atoms so that the overall charge of the oxysalt is 0, or any one of the mentioned inorganic particles which are functionalized;
in an anhydrous solvent;
wherein the at least one inorganic particle is in an amount of 0.01 to 30 wt % related to the amount of polymer;
b) spreading the precursor solution or dispersion obtained in step a) onto a lithium metal anode; and
c) evaporating the solvent and, optionally, carrying out a crosslinking reaction, in order to form a continuous, optionally cross-linked, film over the lithium metal anode.

11. The process according to claim 10, wherein the at least one inorganic particle is in an amount from 0.01 to 20 wt %, or from 0.1 to 20 wt %, or from 0.5 to 20 wt %, or from 1 to 10 wt %, or from 1.5 to 5 wt %, related to the amount of polymer.

12. The process according to claim 10, wherein the inorganic particle is Al₂O₃.

13. A lithium metal battery comprising:
a) a protected anode as defined in claim 1;
b) a cathode; and
c) a suitable electrolyte interposed between the cathode and the anode.

14. The lithium metal battery of claim 13, wherein the protective monolayer further comprises one or more components of the electrolyte capable of diffusing to the protective monolayer in an amount up to 2 wt % with respect to the amount of polymer, wherein the component of the electrolyte capable of diffusing to the protective monolayer is selected from an organic solvent, a lithium salt, an ionic liquid, and mixtures thereof.

15. A method to improve Coulombic efficiency of a lithium battery, the method comprising providing the lithium battery with a lithium metal protected anode as defined in claim 1.

16. The protected anode according to claim 3, wherein the inorganic particle is Al₂O₃.

17. The protected anode according to claim 3, wherein the inorganic particle is a functionalized Al₂O₃.

18. A lithium metal battery comprising:
a) a protected anode as defined in claim 8;
b) a cathode; and
c) a suitable electrolyte interposed between the cathode and the anode.

19. A lithium metal battery comprising:
a) a protected anode as defined in claim 9;
b) a cathode; and
c) a suitable electrolyte interposed between the cathode and the anode.

20. The process according to claim 10, wherein the inorganic particle is a functionalized Al₂O₃.
